(19) United States
(12) Patent Application Publication
(10) Pub. No.: US 2012/0263468 A1
(43) Pub. Date: Oct. 18, 2012

(54) Generation of Optical Quadrature Duobinary Format Using Optical Delay

(75) Inventors: Fatih Yaman, Monmouth Junction, NJ (US); Shaoliang Zhang, Plainsboro, NJ (US); Lei Xu, Princeton Junction, NJ (US); Yin Shao, Plainsboro, NJ (US); Ting Wang, West Windsor, NJ (US)

(73) Assignee: NEC LABORATORIES AMERICA, INC., Princeton, NJ (US)

(21) Appl. No.: 13/446,370

(22) Filed: Apr. 13, 2012

Related U.S. Application Data
(60) Provisional application No. 61/475,300, filed on Apr. 14, 2011.

(51) Int. Cl. H04B 10/04; H04J 14/02; H04J 14/06

(52) U.S. Cl. 398/65; 398/188

(57) ABSTRACT

An optical method for generating an optical quadrature duobinary QDB signal includes receiving a quadrature phase-shift-keying QPSK signal, and adding a delay to the received quadrature phase-shift-keying QPSK signal to generate an optical quadrature duobinary signal.

### RELATED APPLICATION INFORMATION

This application claims priority to provisional application No. 61/475,300 filed Apr. 14, 2011, the contents thereof are incorporated herein by reference

### BACKGROUND OF THE INVENTION

The present invention relates generally to optical communications, and more particularly, to generation of optical quadrature duobinary format using optical delay.

High spectrum efficiency (SE) has received intensive research investigations in the recent optical communication experiments since the exponentially growing Internet traffic drives data rate per channel to 100 Gb/s and beyond. At the fixed standard ITU frequency grid, advanced modulation formats in conjunction with polarization multiplexing are shown to be attractive solutions for supporting ultra-high bit rate. With the advent of high-speed analog-to-digital converters (ADC), optical signals generated with high-order modulation formats can be detected with coherent receivers, and the following digital signal processing (DSP) is further employed to address the various system impairments.

Dual-polarization (DP) quadrature phase-shift-keying (QPSK) is recognized as the popular modulation format for supporting 100 Gb/s data rate due to its optical signal-to-noise ratio (OSNR) receiver sensitivity and high SE. One problem that has to be addressed is that in modern and future network architectures, the signal may have to pass through multiple bandwidth limiting components, such as reconfigurable optical add-drop multiplexers (ROADM). In order to minimize the distortion caused by these filtering, the signal must have narrow enough optical bandwidth to start with.

Recently, compared to conventional DP-QPSK format, quadrature duobinary (QDB) has been proposed to provide higher SE and stronger tolerance to filtering in the optical network because of its narrower spectrum. In this case the challenge is generate the QDB signals with high quality and with low cost.

In the conventional approach, the quadrature duobinary signals are generated in the electrical domain. Two Bessel low-pass filters are used to generate QDB signals using IQ modulator for single channel applications. A three level signal is generated in the electrical domain. These three level signals are used to drive I/Q modulators to generate optical QDB signals. The three level electrical signals are generated either by using a digital transmitter or by filtering two level electrical signals by electrical filters.

Accordingly, there is a need for generating quadrature duobinary QDB signals with high quality and with low cost.

### BRIEF SUMMARY OF THE INVENTION

The present invention is directed an optical method for generating an optical quadrature duobinary QDB signal includes receiving a quadrature phase-shift-keying QPSK signal, and adding a delay to the received quadrature phase-shift-keying QPSK signal to generate an optical quadrature duobinary signal. Preferably, adding the delay is done with an optical delay interferometer that enables parallel conversion of multiple WDM channels on International telecommunications Union ITU grids. Preferably, adding the delay to generate an optical quadrature duobinary signal includes simultaneous conversion from QPSK to QDB for the input signals at orthogonal polarization states and simultaneous conversion from QPSK to QDB for the input signals at WDM wavelength grids. Moreover, adding the delay enables an electrical signal still having two levels and driving I/Q modulators between their extreme transmission points the signal to enable same quality. Further yet, adding the delay entails use of only a single optical delay interferometer ODI being needed to convert regular DP-QPSK signals with both polarizations with multiple wavelengths into QDB, and the ODI imposes no bandwidth limitation.

These and other advantages of the invention will be apparent to those of ordinary skill in the art by reference to the following detailed description and the accompanying drawings.

### BRIEF DESCRIPTION OF THE DRAWINGS

FIG. 1 shows an exemplary transmitter configuration used first to generate an optical DP-QPSK signal for use by the invention;

FIG. a data mapping, in accordance with the invention; and

FIG. 3 shows a flow diagram for the inventive generation of optical quadrature duobinary format using optical delay.

### DETAILED DESCRIPTION

The present invention is directed generating quadrature duobinary QDB signals all optically. The invention can be explained as follows. If the two optical QPSK signals have equal power, their addition can give 9 constellation points, i.e., quadrature duobinary QDB format. Therefore, conventional transmitters can be used first to generate optical QPSK signals. Then using an optical delay and add filter, two optical QPSK signals can be added in phase to generate the QDB signal. In this case, since the QDB signals are generated by adding a QPSK signal to the following QPSK signal from the same stream, a bit mapping process is also presented.

One challenge is to keep the optical carrier phase stable when adding two optical QPSK signals together. One solution to this challenge is to use commercial optical delay interferometers (ODI)s that were originally designed for demodulating differential QPSK in analog receivers. The ODIs are designed to keep a constant phase between the two arms. The ODI's have the additional advantage that they are designed to keep the orthogonality of the input polarizations.

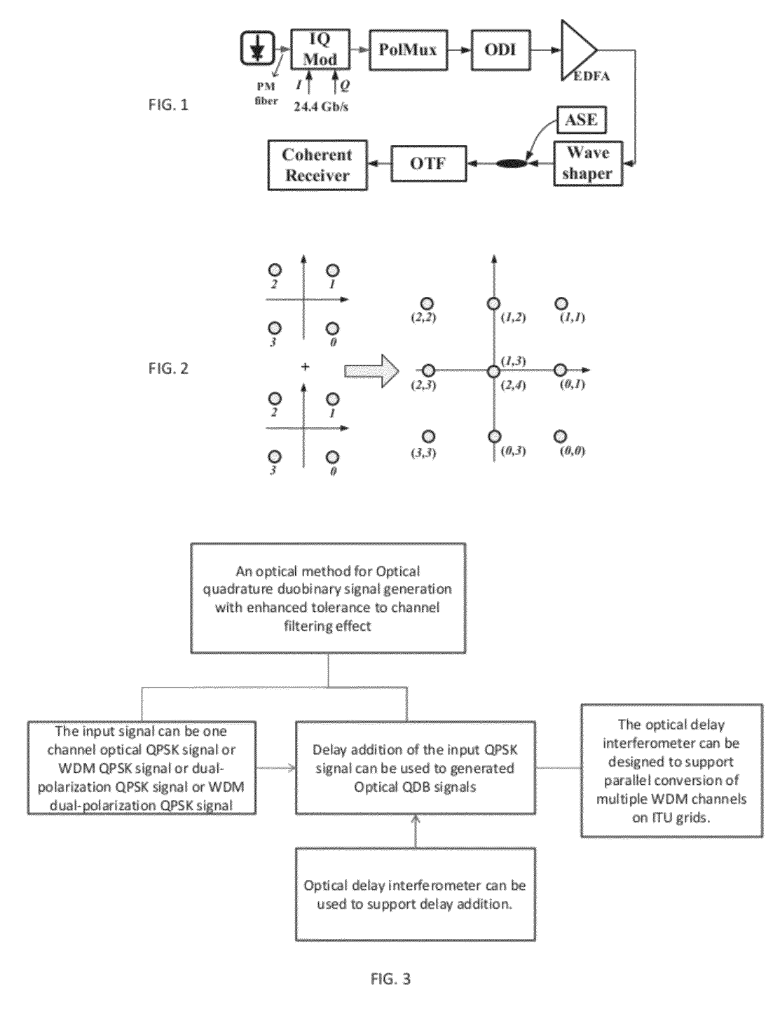

Referring to FIG. 1, there is shown an exemplary DP-QPSK transmitter that is used first to generate the optical DP-QPSK signals. Since regular QPSK transmitters are used without any electrical filters, the signal quality is high. After the transmitter an ODI is used to convert the optical DP-QPSK signals into QDB signals.

In the QPSK transmitter the data has to be encoded accordingly to generate the QDB by the delay and add method. FIG. 2 shows the data mapping. For instance to generate the top left constellation point the two added QPSK signals should both have 1 and 1. To generate the center, the two QPSK signals should have 1, and 3 or, 2 and 4. Because of the redundancy in the QDB constellation, a single stream of DP-QPSK signals can be converted into QDB by a delaying and adding method.

The inventive method uses delayed addition of the input optical dual-polarization QPSK signal to generate dual polarization QDB signal. Unlike prior art approaches, the inventive method can achieve simultaneous conversion from QPSK to QDB for the input signals at orthogonal polarization states. The inventive method can also achieve simultaneous conversion from QPSK to QDB for the input signals at WDM wavelength grids.

The inventive method of using an optical delay interferometer (ODI) achieves a number of advantages over the prior art. Prior art conventional methods generate a three level signal in the electric domain. They use this three level signal to drive the I/Q modulator. It is well known that I/Q modulators work well when they are driven between their minimum or maximum transmission points. In this case, they suppress some of the distortions resulting from electrical signal. However, when the electrical signal has three levels, the middle level necessarily has large noise after modulation. Superior to the prior art technique, when the inventive method is used, the electrical signal still has two levels, and therefore the I/Q modulators are still driven between their extreme transmission points. Therefore the signal quality remains.

When the prior art conventional method is used, an electrical filter is required for each tributary of the final signal including the data in the in phase quandrature, the data in the out of phase quadrature, and also for both quadratures of the both polarization tributaries, and in a WDM system for each WDM channel. As an example, to generate 10 QDB signals for DP-QPSK system one needs 40 electrical filters. In contrast, with the inventive method, only a single ODI is needed to convert regular DP-QPSK signals with both polarizations with multiple wavelengths into QDB.

Electrical filters cannot have large and flat bandwidths. Therefore, in the conventional method the symbol rate for the QDB is limited by the bandwidth of the electrical filters. In the inventive method there is no bandwidth limitation imposed by the ODI.

From the foregoing it can be appreciated that the inventive method enables generating regular dual-polarization QPSK signals using well known low cost transmitters, converting the regular DP-QPSK signals to QDB signals using an optical delay and add method. The inventive method can facilitate use of commercial optical delay interferometers to delay and add the QPSK signals.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. For example, those of ordinary skill in the art will recognize that multiple configurations for the optical processing path shown in FIG. 4 are possible to achieve the same signal transformation effect. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. An optical method for generating an optical quadrature duobinary QDB signal comprising the steps of:
receiving a quadrature phase-shift-keying QPSK signal; and
adding a delay to the received quadrature phase-shift-keying QPSK signal to generate an optical quadrature duobinary signal.

2. The method of claim 1, wherein the QPSK signal comprises one of a one channel optical QPSK signal, a dual polarization QPSK signal and a wavelength division multiplexed WDM dual polarization signal.

3. The method of claim 1, wherein said step of adding a delay comprises use of an optical delay interferometer.

4. The method of claim 3, wherein optical delay interferometer enables parallel conversion of multiple WDM channels on International telecommunications Union ITU grids.

5. The method of claim 1, wherein said adding a delay to generate an optical quadrature duobinary signal comprises simultaneous conversion from QPSK to QDB for the input signals at orthogonal polarization states and simultaneous conversion from QPSK to QDB for the input signals at WDM wavelength grids.

6. The method of claim 5, wherein said adding a delay to generate an optical quadrature duobinary signal comprises an electrical signal still having two levels and driving I/Q modulators between their extreme transmission points the signal to enable same quality.

7. The method of claim 6, wherein said adding a delay to generate an optical quadrature duobinary signal comprises only a single optical delay interferometer ODI being needed to convert regular DP-QPSK signals with both polarizations with multiple wavelengths into QDB, said ODI imposing no bandwidth limitation.
